(19) United States
(12) Patent Application Publication
(10) Pub. No.: US 2016/0286036 A1
(43) Pub. Date: Sep. 29, 2016

(54) METHOD FOR QUICK ACCESS TO APPLICATION FUNCTIONALITIES

(71) Applicant: ORANGE, Paris (FR)

(72) Inventor: Cedric Floury, Perros Guirec (FR)

(21) Appl. No.: 15/077,835

(22) Filed: Mar. 22, 2016

(30) Foreign Application Priority Data
Mar. 27, 2015 (FR) 1552608

(51) Int. Cl. H04M 1/725; G06F 3/0484; G06F 3/0482; G06F 3/0488; G06F 3/0481

(52) U.S. Cl. CPC H04M 1/72586; G06F 3/04883; G06F 3/04817; G06F 3/0482; G06F 3/04842

(57) ABSTRACT

The invention relates to a method for quick access to application functionalities on a terminal comprising a touchscreen, characterized in that it comprises steps for detecting a gesture performed by the movement of a point of contact over the screen of the terminal, whose origin is situated at a location on the screen where an icon for launching an application is displayed; for displaying a set of elements for quick access to functions of the application according to a predefined selection criterion; and for enabling the corresponding function when a quick access element is selected. The invention also relates to a device and a terminal implementing the quick access method.

### TECHNICAL FIELD

The invention relates to the field of user interfaces and relates, more particularly, to a method allowing the access to certain data of a terminal to be accelerated.

### PRIOR ART

Communications technologies have undergone a very rapid development in the last few years. Connected mobile terminals in particular, such as for example intelligent telephones known as smartphones, have become common amongst the general population and today occupy a central place in the life of their users. Users may be contacted at all times according to various modes of operation and share all kinds of information with others, where and when they desire it.

The use of the smartphone occupies a large part of the time of their owners because its uses are very varied: internet, communications, diary, reading, photo, video, television, games, etc. These terminals are upgradable and offer the possibility for their users to add new functionalities by downloading and installing adapted programs called “applications”. An application is conventionally represented by an icon displayed on a screen of the terminal and executed when the corresponding icon is selected. Thus, a smartphone must offer a particularly efficient interface allowing the users to quickly access information or a functionality from amongst the whole set of data which it has available.

For this purpose, a large majority of the smartphones on the market are equipped with a user interface of the touchscreen type. A touch-sensitive interface is particularly advantageous on this type of device since it allows the use of physical buttons to be limited enabling larger screens to be used and affords an extremely intuitive user experience. Users can thus interact with their terminals by simple gestures effected with one or more fingers on the screen.

In order to further reduce the interactions needed for accessing certain functionalities, the majority of the operating systems for mobile terminals of the smartphone type furthermore allow the icons for launching applications to be re-organized on the screen in such a manner that the users can highlight and make immediately accessible the functions that they use most frequently. On the other hand, the applications frequently use shortcuts of the type “favorites” or “recent places” in order to optimize the access to functions that they comprise. For example, internet browsers have for a long time included a bookmark system so that the users can directly access their favorite internet sites. Similarly, telephony applications may include a call log for accessing recently used numbers or else a system for favorite contacts that could be automatically constituted by an observation of the frequency of use of the numbers. The access to these favorite elements can however prove to be tedious because the application in question must firstly be launched in order to access it. This is time-consuming and consumes energy resources of the terminal.

It may be noted that, in the latter case, since the telephony function is a key element in a communications terminal, the management of the address and favorite contacts book is sometimes directly integrated into the operating system and is immediately accessible via a dedicated button or icon. In this way, it is possible to establish a communication with a contact via a minimum number of actions. Unfortunately, this way of operating cannot currently be generalized without being detrimental to the user-friendliness of the terminal.

Thus, there indeed exists a need for a solution allowing a fast and user-friendly access to data or functions relating to various applications.

### SUMMARY OF THE INVENTION

For this purpose, the invention relates to a method for quick access to application functionalities on a terminal comprising a touchscreen characterized in that it comprises the following steps:
Detection of a gesture performed by the movement of a point of contact over the screen of the terminal, whose origin is situated at a location on the screen where an icon for launching an application is displayed,
Displaying, according to a predefined selection criterion, of a set of elements for quick access to functions of the application, and
Enabling the corresponding function when a quick access element is selected.

The gesture performed starting from the icon of an application thus allows the displaying of a set of quick access elements relating to this application to be triggered. The gesture is taken into account when it corresponds to a movement of a contact with the screen, for example the movement of a finger or of a suitable object over the screen with an application icon as starting point. In this way, it is possible to differentiate an action for launching the application from a gesture triggering the display of the quick access elements. Such a gesture having, as a starting point, the icon of a communications application can trigger the displaying of buttons associated with particular entries in an address book. By an action on one of these buttons, the user can then trigger the establishment of a communication with the associated contact. According to another example, a gesture originating on the icon for launching a photography application may, in the same way, cause the display of a thumbnail of the latest photos taken by the terminal, an action on the thumbnail then allowing the displaying of the photo in a large format. These examples are non-limiting and the application may be applied to numerous types of application such as for example a web browser, a diary, a messaging application, etc.

A simple single action allows access to be quickly gained to an element for accessing functions of the application: the limited number of actions for accessing a function allows a gain in time which results in a reduced consumption of resources on the terminal and an energy saving.

On the other hand, the invention may be involved with a large number of applications. The elements displayed relate to the application targeted by the origin of the gesture, which allows an easier readability by avoiding a visual pollution by information relating to other applications.

The quick access elements displayed following the detection of the gesture are selected according to a predefined criterion such as for example a history or a frequency of use of the application. The selection criterion may also comprise, according to one particular embodiment of the invention, a geographic localization of the terminal or a particular network to which the terminal is connected in such a manner as to provide for example quick access elements relating to entries in a company address book when the terminal is located at a workplace and entries in a personal address book when the terminal is located at the home of its user.

According to one particular embodiment, the method is such that the number of quick access elements displayed depends on the distance of travel of the point of contact.

Thus, the idea of the invention is to make the number of quick access elements correspond to the distance travelled by the contact over the screen of the terminal. For example, when a user performs a short gesture starting from the icon for launching a communications application, a small number of quick access elements is displayed. On the other hand, if the gesture detected is long, a larger number of quick access elements is displayed. The invention thus allows the interactions necessary for the establishment of the communication to be limited when the contact sought is the first quick access element. Conversely, the user may continue the gesture so as to make more quick access elements appear until the element sought is displayed.

According to one particular embodiment, the method is such that the gesture is a vertical movement of the point of contact over the screen.

The displaying of the quick access elements is triggered by a gesture whose origin is the icon for launching an application and which continues by a vertical movement of the contact with the screen. Thus, when an application icon is for example positioned at the bottom of a screen, the user can perform a rectilinear gesture upward over the screen in order to make the quick access elements appear. Conversely, if the icon is situated at the top of the screen, the user can make the gesture downward over the screen in order to make these same elements appear. This embodiment of the invention advantageously allows an area situated between the icon and the position of the end of the movement of the point of contact to be clearly defined in order to display the quick access elements, where the number of elements displayed can depend on the space available for displaying the elements within the area. For example, the quick access elements may be disposed in a column whose height corresponds to the distance between the icon for the application and the position of the finger of a user—or of any given adapted pointing object—on the screen.

According to one particular embodiment, the method is such that it furthermore comprises the following steps:
Detection of a second gesture performed consecutively to the first gesture, and
Displaying, according to a predefined selection criterion, of a second set of elements for quick access to functions of the application.

When the number of access elements displayed depends on the length of the movement of the contact over the screen, it can happen that the maximum distance that can be covered does not allow the display of a quick access element sought. For example, if the icon for launching a communications application is situated in the middle of the screen, the maximum distance that it is possible to cover by moving a finger vertically from the icon is limited. In such a manner as to allow the displaying of the largest number of quick access elements, the invention provides for a second gesture to be able to be carried out consecutively to the initial gesture, the second gesture, when it is detected, allowing a second set of quick access elements to be displayed. This second gesture may for example correspond to a horizontal movement of the contact detected on the screen consecutive to the vertical movement having initially triggered the displaying of the first set of quick access elements. When this horizontal movement is detected, the terminal may display, for example in the form of additional columns, a number of additional quick access elements proportional to the length of the horizontal movement.

According to one particular embodiment, the method is such that the selection of the quick access elements is made according to a criterion on frequency of use of said elements.

The quick access elements displayed are selected according to the frequency of use of the objects to which they relate. For example, the most used entries in an address book may be selected and displayed in order of frequency of decreasing use when a gesture starting from the icon of a communications application is detected. Thus, a very short gesture allows only the elements to be displayed that have the highest probability of being used by the user.

According to one particular embodiment, the method is such that the selection of the quick access elements is made according to a criterion relating to the date of last use of said elements.

In this way, the invention allows a quick access to the latest elements consulted, used or produced. For example, when the invention is associated with the icon of a photography application, the user can advantageously quickly access the latest photos taken or else, in the case of an internet browser, the latest pages visited.

According to one particular embodiment, the method is such that the quick access elements are displayed in the foreground and in that a blurring effect is applied to the graphics elements of the background previously displayed.

The application of a graphics effect such as a blurring or a de-saturation of the elements displayed prior to the appearance of the quick access elements allows these elements to stand out more clearly from the background. By allowing the user to focus on the access elements, the invention can accelerate the access to the desired functionality.

According to another aspect, the invention relates to a device for quick access to application functionalities comprising a touchscreen characterized in that it comprises:
A unit for detecting a gesture carried out by the movement of a point of contact over the screen of the terminal, whose origin is situated at a location on the screen where an icon for launching an application is displayed,
A display device designed to display a set of elements for quick access to functions of the application according to a predefined selection criterion, and
A unit for enabling the corresponding function when a quick access element is selected.

The invention also relates to a terminal comprising a device for quick access to application functionalities.

The invention also relates to a computer program comprising the instructions for the execution of the quick access method, when the program is executed by a processor.

The invention also relates to an information medium readable by a processor on which a computer program is recorded that comprises instructions for the execution of the steps of the quick access method.

The various aforementioned embodiments and features may be added, independently or in combination with one another, to the steps of the quick access method.

The terminals, devices, programs and information media exhibit at least advantages analogous to those offered by the quick access method described hereinabove.

### LIST OF THE FIGURES

Other features and advantages of the invention will become more clearly apparent upon reading the following description of one particular embodiment, presented by way of one simply illustrative and non-limiting example, and from the appended drawings, amongst which:

FIGS. 1a, 1b and 1c illustrate one implementation of the invention on a terminal according to one particular embodiment.

FIG. 2 illustrates the main steps of the quick access method according to one particular embodiment of the invention,

FIG. 3 shows schematically one example of an architecture of a device designed to implement the quick access method according to one particular embodiment of the invention.

### DETAILED DESCRIPTION

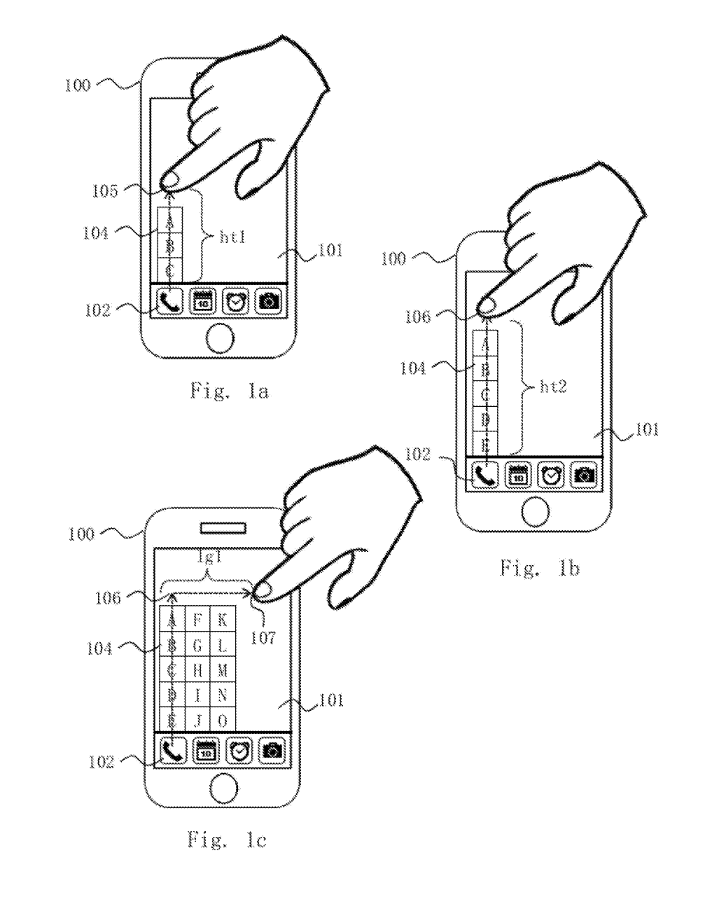

FIG. 1a illustrates a terminal 100 implementing the present invention according to one particular embodiment. It should be noted here that, although the terminal 100 illustrated in the figure corresponds here to a mobile terminal of the smartphone type, the invention is also applicable to any type of terminal equipped with a touchscreen, such as for example, and in a non-limiting manner, a touchscreen tablet, an electronic reader, a games console, a control terminal of a smart home management system, equipment of a driver assist system or else a personal computer.

The terminal 100 comprises a touchscreen 101 designed to localize contacts with an object or a part of the body of the user on the screen. A screen of the capacitive or resistive type is for example suitable for implementing the invention.

The terminal 100 comprises a processor designed to execute an operating system and one or more applications stored in a memory, such as for example a RAM (Random Access Memory) memory or a Flash memory. Conventionally, a user of the terminal 100 launches the execution of an application by performing an action on the corresponding icon. For this purpose, the terminal interprets the action of the user according to what is displayed on the screen at the location where the action is carried out. For example, a user of the terminal 100 can touch the screen at the location of the icon 102 in order to launch a communications application on the terminal. When the application has been launched, a user of the terminal can, again conventionally, consult an address book and trigger the establishment of a communication with a contact.

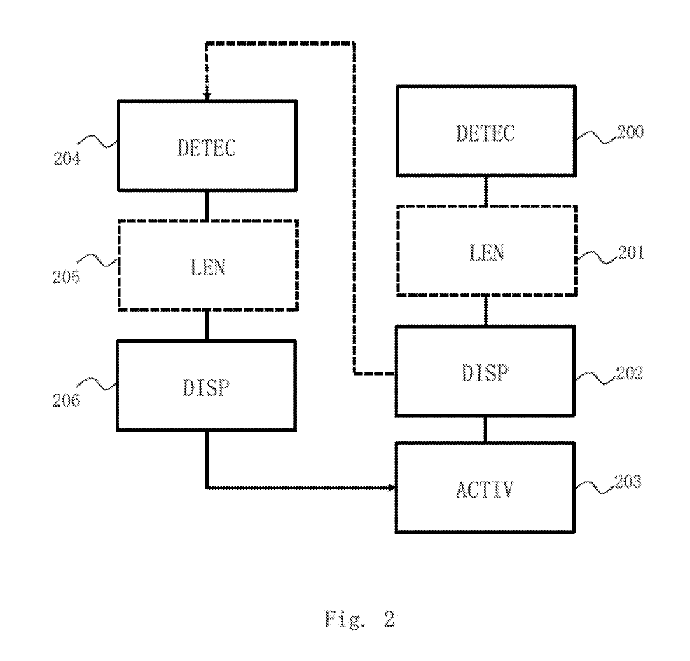

FIG. 2 illustrates the main steps of the quick access method. During a first step 200, the terminal detects a gesture performed by a user, the gesture consisting of a movement of a point of contact over the screen of the terminal starting from a location on the screen where an icon for launching an application is displayed. For example, the terminal detects that the user is placing his/her finger on the screen at the location of the icon 102 and is performing a upward movement on the screen. For this purpose, the terminal combines data supplied by the touchscreen relating to the position of the point of contact on the screen and data relating to the location of the icons on the screen, where the latter data may be supplied for example by the operating system of the terminal.

One optional step 201 consists in measuring the movement of the point of contact with respect to its position of origin. According to one particular embodiment, the measurement of the movement corresponds to the distance travelled by the point of contact over the screen during its movement. According to one preferred embodiment, the measurement of the movement corresponds to the distance separating the initial position of the point of contact and its position at the time of the measurement. The distance may be calculated with reference to a particular axis, for example along a vertical axis or a horizontal axis or else may be calculated along two axes. For example, when the measurement relates to a vertical movement of the point of contact, the distance measured may correspond to the absolute value of the difference in the vertical coordinates at the points of departure and of arrival of the movement of the point of contact. Thus, with reference to FIG. 1a, the distance of travel of the point of contact is denoted ht1 and corresponds to the distance between the position of the icon 102 on the screen and the position of the point of contact 105.

At the step 202, the terminal implements the display of a set of elements for quick access to functionalities of the application, the quick access elements displayed being selected according to a predefined criterion. For this purpose, the terminal determines the application in question based on the location of origin of the gesture and consults, for example, a database in which functionalities or data relating to said application are stored in order to select a sub-set of these functionalities or data. The functionalities or data selected can subsequently be associated with user interface elements such as buttons or icons and displayed on the screen of the terminal, an action on these user interface elements causing the functionality to be enabled or the associated data to be displayed. For example, a quick access button may be associated with a command for execution of the application matched with a parameter making reference to the functionality or to the data for which a quick access is desired, the application being designed to interpret this parameter automatically when it is executed. Thus, following the detection of a gesture performed on the terminal 100 in FIG. 1a, starting from the icon 102 associated with a communications application up to the location 105, the terminal selects three entries A, B and C in an address book and associates these three entries with user interface elements presented on the screen of the terminal. According to one particular embodiment, the quick access elements are presented in an area of the screen whose dimensions correspond to the measured movement of the point of contact. For example, the quick access elements may be displayed in a rectangular area 104 whose height corresponds to the vertical distance between the location of the icon and the location of the point of contact on the screen.

According to one particular embodiment, the number of quick access elements depends on the distance of travel of the point of contact. For example, FIG. 1b shows the terminal 100 after the point of contact has been moved to a location 106. The vertical distance ht2 between the icon 102 and the location 106 of the point of contact is greater than the distance ht1 shown in FIG. 1a and two new quick access elements D and E, corresponding to two other entries of the address book, have been able to be displayed in the area 104. The method thus allows the user to halt his/her gesture as soon as an element sought is displayed so as to reduce the time for accessing the functionality or the data sought.

According to one particular embodiment, the quick access elements displayed are selected from amongst a set of data or of functionalities according to a criterion on frequency of use. For example, the quick access elements A, B and C shown in FIG. 1a may correspond to the three most frequently used entries in the address book of the terminal. In this way, the functionality or the data with the highest probability of use is displayed first of all.

According to one particular embodiment, the quick access elements displayed are selected from amongst a set of data or of functionalities according to a chronological criterion. For example, the quick access elements A, B, C, D and E shown in FIG. 1b may correspond to the five most recently used entries in the address book of the terminal.

Thus, the access to a frequently used or recently used functionality only requires a short gesture. The method thus allows the user to save time and the terminal to economize resources.

According to one particular embodiment, the quick access elements are selected according to a geographic localization criterion. For this purpose, the terminal can use a localization component such as a GPS (Global Positioning System) for determining its geographic location and determining, for example, whether the user is at home or at his/her workplace. Thus, when the terminal is located at the workplace of the user, the quick access elements can be selected within a professional address book previously associated by the user with a particular location. This allows manipulations that are time-consuming and energy-consuming for the terminal to be limited.

According to one particular embodiment, a visual effect is applied to the background when the quick access elements are displayed. For example, the icons or other graphics elements displayed on the screen before the appearance of the quick access elements may be rendered blurred by application of a Gaussian blurring effect when the access elements are displayed. By thus making the quick access elements stand out with respect to the background, the quick access elements may be more readily identified by the user, which in turn allows a further reduction in the time for accessing the functions or data of the application.

At the step 203, the terminal detects an action on a quick access element and enables the function associated with this element. For example, when the terminal detects an action on the quick access element B in FIG. 1b, the terminal may execute a command causing the establishment of a communication with the contact associated with this element. In this way, the method allows the establishment of a communication with a contact using fast and simple gestures.

According to one particular embodiment, the displaying step 202 may be followed by an optional step 204 for detecting a second gesture performed consecutively to the first gesture. The second gesture may for example consist of a horizontal movement of the point of contact carried out as a continuation of the first gesture.

The terminal may evaluate the distance of travel of the second gesture during an optional step 205. For this purpose, the terminal may for example evaluate the horizontal distance covered during the movement of the point of contact by calculating for example the separation between the position of the point contact at the start of the second gesture and its position at the time of the calculation.

At the step 206, the terminal may display at least one new additional quick access element when a second gesture is detected. This new set of elements is composed of elements for accessing functions or data of the application determined by the origin of the first gesture, the access elements being selected according to a predefined criterion, such as for example a chronological criterion or a criterion relating to the frequency of use of the functions or data. According to one particular embodiment, the number of access elements included in the new set depends on the distance of travel evaluated at the step 205. The method thus allows more access elements to be displayed whenever necessary. By providing more quick access elements, the method allows the number of cases to be reduced in which a user will have to perform more complex manipulations in order to access a particular functionality not available amongst the quick access elements.

FIG. 1c shows the terminal 100 when the user performs a second gesture as a continuation of the first gesture. A first vertical movement of a point of contact over the screen starting from the display location of the icon 102 up to the location 106 causes a first set of quick access elements {A, B, C, D, E} to be displayed as shown in FIG. 1b. Starting from the location 106, the user then performs a horizontal movement of the point of contact to the location 107. Upon detection of the second gesture, the terminal displays a new set of quick access elements, the number of elements in the new set relating to the distance of travel of the second gesture. For example, in FIG. 1c, the movement of the point of contact over a distance Ig1 causes the displaying of 10 additional quick access elements {F, G, H, I, J, K, L, M, N, O}.

The method thus allows a large number of elements to be accessed enabling a quick access to functions or data associated with a particular application. In this way, the number of interactions for accessing functions or data can be significantly reduced with respect to the current techniques, a fact which contributes to economizing the resources of the terminal. In particular, when the quick access elements are selected and ordered according to their frequency of use and/or in a chronological manner, the time for accessing the function or the corresponding data is greatly limited. It goes without saying that other directions of the gesture may be applied and the sequence of change of direction may be reversed for implementing the invention.

Following the appearance of the quick access elements, the initial display may be re-established in various ways. For example, the quick access elements may be masked after the expiration of a predetermined time period when no action has been carried out by the user. According to one particular embodiment, the elements may be masked when an action is carried out over an area of the screen which does not comprise any quick access elements.

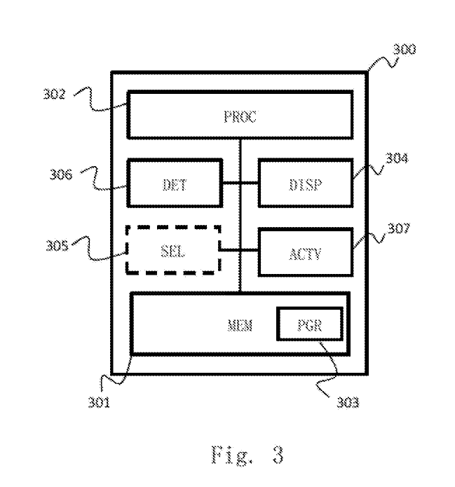

FIG. 3 illustrates a device 300 implementing the quick access method, according to one particular embodiment of the invention. The device comprises a storage space 301, for example a memory MEM, a processing unit 302 equipped for example with a processor PROC. The processing unit can be controlled by a program 303, for example a computer program PGR, implementing the quick access method such as described in the invention with reference to FIGS. 1 and 2, and notably the steps for detecting a gesture performed by the movement of a point of contact over the screen of the terminal, whose origin is situated at a location on the screen where an icon for launching an application is displayed, for displaying, according to a predefined selection criterion, a set of elements for quick access to functions of the application, and for enabling the corresponding function when a quick access element is selected.

Upon initialization, the instructions of the computer program 303 (PGR) are for example loaded in a RAM (Random Access Memory) memory prior to being executed by the processor of the processing unit 302. The instructions of the program may also be stored on or in a storage medium such as a flash memory, a hard disk or any other non-transient storage medium. The processor of the processing unit 302 implements the steps of the quick access method according to the instructions of the computer program 303.

For this purpose, the device comprises, aside from the memory 301, a display module 304 (DISP) allowing the device to display graphics elements and, in particular, to display quick access elements. The device also comprises a unit 306 (DET) for detecting a point of contact on the screen, such as for example a touch-sensitive plate designed to detect a contact between an object or a part of the body and the touch-sensitive plate. According to one particular embodiment, the detection unit and the display unit are combined in the form of a touchscreen for example. According to one particular embodiment, the device also comprises a unit for selecting, according to a predetermined criterion, a set of quick access elements to be displayed. In particular, the selection unit is adapted for determining the functions or the data of an application according to a criterion on frequency of use. The device furthermore comprises an activation unit 307 (ACTV) designed to enable the execution of a function or the displaying of data when a quick access element is selected by a user.

According to one particular embodiment, the device may be integrated into a terminal of the smartphone type, a touchscreen tablet, a personal computer, a control center of a smart home management system, an onboard computer in a vehicle or else a navigation module of the GPS (Global Positioning System) type.

1. Method for quick access to application functionalities on a terminal comprising a touchscreen characterized in that it comprises the following steps:
Detection (200) of a gesture performed by the movement of a point of contact over the screen of the terminal, whose origin is situated at a location on the screen where an icon for launching an application is displayed,
Displaying (202), according to a predefined selection criterion, of a set of elements for quick access to functions of the application,
Detection of a second gesture performed consecutively to the first gesture,
Displaying, according to a predefined selection criterion, of a second set of elements for quick access to functions of the application, the number of elements of the first and of the second set being respectively a function of the length of the first and second gestures, and
Enabling (203) of the corresponding function when a quick access element is selected.

2. Method according to claim 1 characterized in that the gesture is a vertical movement of the point of contact over the screen.

3. Method according to claim 1 characterized in that the selection of the quick access elements is made according to a criterion of frequency of use of said elements.

4. Method according to claim 1 characterized in that the selection of the quick access elements is made according to a criterion relating to the date of last use of said elements.

5. Method according to claim 1 characterized in that the quick access elements are displayed in the foreground and in that a blurring effect is applied to the graphics elements of the background previously displayed.

6. Device for quick access to application functionalities comprising a touchscreen, characterized in that it comprises:
A unit for detecting a gesture performed by the movement of a point of contact over the screen of the terminal, whose origin is situated at a location on the screen where an icon for launching an application is displayed,
A display device designed to display a set of elements for quick access to functions of the application according to a predefined selection criterion, and
A unit for enabling the corresponding function when a quick access element is selected.

7. Terminal characterized in that it comprises a quick access device for quick access to application functionalities comprising a touchscreen, characterized in that it comprises:
A unit for detecting a gesture performed by the movement of a point of contact over the screen of the terminal, whose origin is situated at a location on the screen where an icon for launching an application is displayed,
A display device designed to display a set of elements for quick access to functions of the application according to a predefined selection criterion, and
A unit for enabling the corresponding function when a quick access element is selected.

8. Computer program comprising instructions for execution of a quick access method, when the program is executed by a processor, the method for quick access to application functionalities on a terminal comprising a touchscreen characterized in that it comprises the following steps:
Detection (200) of a gesture performed by the movement of a point of contact over the screen of the terminal, whose origin is situated at a location on the screen where an icon for launching an application is displayed,
Displaying (202), according to a predefined selection criterion, of a set of elements for quick access to functions of the application,
Detection of a second gesture performed consecutively to the first gesture,
Displaying, according to a predefined selection criterion, of a second set of elements for quick access to functions of the application, the number of elements of the first and of the second set being respectively a function of the length of the first and second gestures, and
Enabling (203) of the corresponding function when a quick access element is selected.

9. Information medium readable by a processor on which a computer program is recorded that comprises instructions for execution of steps of a quick access method, the method for quick access to application functionalities on a terminal comprising a touchscreen characterized in that it comprises the following steps:
Detection (200) of a gesture performed by the movement of a point of contact over the screen of the terminal, whose origin is situated at a location on the screen where an icon for launching an application is displayed,
Displaying (202), according to a predefined selection criterion, of a set of elements for quick access to functions of the application,
Detection of a second gesture performed consecutively to the first gesture,
Displaying, according to a predefined selection criterion, of a second set of elements for quick access to functions of the application, the number of elements of the first and of the second set being respectively a function of the length of the first and second gestures, and
Enabling (203) of the corresponding function when a quick access element is selected.

10. Method according to claim 2 characterized in that the selection of the quick access elements is made according to a criterion of frequency of use of said elements.

11. Method according to claim 2 characterized in that the selection of the quick access elements is made according to a criterion relating to the date of last use of said elements.

12. Method according to claim 3 characterized in that the selection of the quick access elements is made according to a criterion relating to the date of last use of said elements.

13. Method according to claim 2 characterized in that the quick access elements are displayed in the foreground and in that a blurring effect is applied to the graphics elements of the background previously displayed.

14. Method according to claim 3 characterized in that the quick access elements are displayed in the foreground and in that a blurring effect is applied to the graphics elements of the background previously displayed.

15. Method according to claim 4 characterized in that the quick access elements are displayed in the foreground and in that a blurring effect is applied to the graphics elements of the background previously displayed.

16. The computer program according to claim 8 characterized in that the gesture is a vertical movement of the point of contact over the screen.

17. The computer program according to claim 8 characterized in that the selection of the quick access elements is made according to a criterion of frequency of use of said elements.

18. The computer program according to claim 8 characterized in that the selection of the quick access elements is made according to a criterion relating to the date of last use of said elements.

19. The computer program according to claim 8 characterized in that the quick access elements are displayed in the foreground and in that a blurring effect is applied to the graphics elements of the background previously displayed.

20. The information medium according to claim 9 characterized in that the gesture is a vertical movement of the point of contact over the screen.

21. The information medium according to claim 9 characterized in that the selection of the quick access elements is made according to a criterion of frequency of use of said elements.

22. The information medium according to claim 9 characterized in that the selection of the quick access elements is made according to a criterion relating to the date of last use of said elements.

23. The information medium according to claim 9 characterized in that the quick access elements are displayed in the foreground and in that a blurring effect is applied to the graphics elements of the background previously displayed.
